(19) United States
(12) Patent Application Publication
(10) Pub. No.: US 2025/0118214 A1
(43) Pub. Date: Apr. 10, 2025

(54) MANAGEMENT APPARATUS, CONTROL APPARATUS, METHOD, PROGRAM, AND RECORDING MEDIUM

(71) Applicant: NEC Corporation, Tokyo (JP)

(72) Inventor: Toshiyuki TAMURA, Tokyo (JP)

(73) Assignee: NEC Corporation, Tokyo (JP)

(21) Appl. No.: 18/981,710

(22) Filed: Dec. 16, 2024

Related U.S. Application Data
(62) Division of application No. 17/633,642, filed on Feb. 8, 2022.

(30) Foreign Application Priority Data
Sep. 4, 2019 (JP) 2019-161402

(51) Int. Cl. G08G 5/00; B64U 101/20; H04W 84/04

(52) U.S. Cl. CPC G08G 5/34; G08G 5/56; B64U 2101/20; B64U 2201/102; H04W 84/042

(57) ABSTRACT

There is provided a management apparatus configured to allocate a plurality of zones capable of identifying a three-dimensional space in common among a plurality of mobile communication carrier networks to a flight airspace allowing a plurality of mobile terminals to be flown, the plurality of mobile terminals being configured to respectively perform wireless communication with the plurality of mobile communication carrier networks, and configured to transmit information on allocation of the plurality of zones to a mobile communication network respectively managed by the plurality of mobile communication carriers.

This application is a divisional application of U.S. application Ser. No. 17/633,642 filed on Feb. 8, 2022, which is a National Stage Entry of PCT/JP2020/033106 filed on Sep. 1, 2020, which claims priority from Japanese Patent Application 2019-161402 filed on Sep. 4, 2019, the contents of all of which are incorporated herein by reference, in their entirety.

### BACKGROUND

### Technical Field

The present invention relates to a management apparatus, a control apparatus, a method, a program, and a recording medium.

### Background Art

Mobile terminals (drone or the like) that perform flight according to information on a flight path received from a server or the like via a communication network have been widely known.

For example, PTL 1 discloses a configuration of allocating a flight airspace and a flight permission period to a drone based on flight scheduled information transmitted from each business terminal, and when there is predetermined commonality in flight airspaces and flight directions of a plurality of drones, causing sharing of the flight airspaces on the condition that the plurality of drones perform formation flight.

Further, PTL 2 discloses a configuration of, when an allocation request of a flight airspace of a drone is received from a plurality of business operators, allocating the flight airspace with a business operator having high priority based on past performance of allocation of each business operator being prioritized over other business operators.

In addition, PTL 3 discloses a configuration in which an unmanned aircraft (UAV) moves ahead in accordance with a plan via a wireless communication network, and cells of the wireless communication network through which the UAV is to pass and time at which these cells are to be passed through are defined.

### CITATION LIST

### Patent Literature

[PTL 1] WO 2019/054056
[PTL 2] WO 2019/093197
[PTL 3] JP 2017-528931 A

### SUMMARY

### Technical Problem

The above-described mobile terminals such as a drone and a UAV perform communication with a management apparatus that performs management of a flight via any mobile communication carrier network. Thus, for example, it is assumed that each of a plurality of mobile terminals flying near each other performs wireless communication with mobile communication carrier networks different from each other.

However, for example, in the technologies disclosed in PTLs 1 to 3, for example, when a plurality of mobile terminals as described above respectively perform wireless communication with mobile communication carrier networks different from each other, the flight of each of the mobile terminals cannot be appropriately managed.

An example object of the present invention is to provide a management apparatus, a control apparatus, a method, a program, and a recording medium that enable appropriate support of a flight of a mobile terminal that performs wireless communication with a mobile communication carrier network.

### Solution to Problem

According to an example aspect, a management apparatus includes: an allocation processing section configured to allocate a plurality of zones, each of which being identified by latitude, longitude, and altitude as a three-dimensional space in common among a plurality of mobile communication carrier networks, to a flight airspace allowing a plurality of mobile terminals to be flown, the plurality of mobile terminals being configured to respectively perform wireless communication with the plurality of mobile communication carrier networks; and a communication processing section configured to transmit information on allocation of the plurality of zones to the plurality of mobile communication carrier networks.

According to an example aspect, a control apparatus includes: a communication processing section configured to receive, from a management apparatus managing a plurality of zones, information on allocation of the plurality of zones allocated to a flight airspace allowing a plurality of mobile terminals to be flown, the plurality of mobile terminals being configured to respectively perform wireless communication with a plurality of mobile communication carrier networks, the information being information on the allocation of the plurality of zones, each of which being identified by latitude, longitude, and altitude as a three-dimensional space in common among the plurality of mobile communication carrier networks; and a control section configured to perform processing for one or more first mobile terminals being configured to perform wireless communication with a first mobile communication carrier network, based on the information on the allocation of the plurality of zones.

According to an example aspect, a first method includes: allocating a plurality of zones, each of which being identified by latitude, longitude, and altitude as a three-dimensional space in common among a plurality of mobile communication carrier networks, to a flight airspace allowing a plurality of mobile terminals to be flown, the plurality of mobile terminals being configured to respectively perform wireless communication with the plurality of mobile communication carrier networks; and transmitting information on allocation of the plurality of zones to the plurality of mobile communication carrier networks.

According to an example aspect, a second method includes: receiving, from a management apparatus managing a plurality of zones, information on allocation of the plurality of zones allocated to a flight airspace allowing a plurality of mobile terminals to be flown, the plurality of mobile terminals being configured to respectively perform wireless communication with a plurality of mobile communication carrier networks, the information being information on the allocation of the plurality of zones, each of which being identified by latitude, longitude, and altitude as a three-dimensional space in common among the plurality of mobile communication carrier networks; and performing processing for one or more first mobile terminals being configured to perform wireless communication with a first mobile communication carrier network, based on the information on the allocation of the plurality of zones.

According to an example aspect, a first program causes a processor to execute: allocating a plurality of zones, each of which being identified by latitude, longitude, and altitude as a three-dimensional space in common among a plurality of mobile communication carrier networks, to a flight airspace allowing a plurality of mobile terminals to be flown, the plurality of mobile terminals being configured to respectively perform wireless communication with the plurality of mobile communication carrier networks; and transmitting information on allocation of the plurality of zones to the plurality of mobile communication carrier networks.

According to an example aspect, a second program causes a processor to execute: receiving, from a management apparatus managing a plurality of zones, information on allocation of the plurality of zones allocated to a flight airspace allowing a plurality of mobile terminals to be flown, the plurality of mobile terminals being configured to respectively perform wireless communication with a plurality of mobile communication carrier networks, the information being information on the allocation of the plurality of zones, each of which being identified by latitude, longitude, and altitude as a three-dimensional space in common among the plurality of mobile communication carrier networks; and performing processing for one or more first mobile terminals being configured to perform wireless communication with a first mobile communication carrier network, based on the information on the allocation of the plurality of zones.

According to an example aspect, a first non-transitory computer readable recording medium stores a program that causes a processor to execute: allocating a plurality of zones, each of which being identified by latitude, longitude, and altitude as a three-dimensional space in common among a plurality of mobile communication carrier networks, to a flight airspace allowing a plurality of mobile terminals to be flown, the plurality of mobile terminals being configured to respectively perform wireless communication with the plurality of mobile communication carrier networks; and transmitting information on allocation of the plurality of zones to the plurality of mobile communication carrier networks.

According to an example aspect, a second non-transitory computer readable recording medium stores a program that causes a processor to execute: receiving, from a management apparatus managing a plurality of zones, information on allocation of the plurality of zones allocated to a flight airspace allowing a plurality of mobile terminals to be flown, the plurality of mobile terminals being configured to respectively perform wireless communication with a plurality of mobile communication carrier networks, the information being information on the allocation of the plurality of zones, each of which being identified by latitude, longitude, and altitude as a three-dimensional space in common among the plurality of mobile communication carrier networks; and performing processing for one or more first mobile terminals being configured to perform wireless communication with a first mobile communication carrier network, based on the information on the allocation of the plurality of zones.

### Advantageous Effects of Invention

According to the present invention, when a plurality of mobile terminals perform wireless communication with mobile communication carrier networks different from each other, a flight of each of the mobile terminals can be appropriately managed. Note that, according to the present invention, instead of or together with the above effects, other effects may be exerted.

### BRIEF DESCRIPTION OF THE DRAWINGS

FIG. 1 is an explanatory diagram illustrating an example of a schematic configuration of a system 1 according to example embodiments of the present invention;

FIG. 2 is a block diagram illustrating an example of a schematic configuration of a management apparatus 100 according to a first example embodiment;

FIG. 3 is a block diagram illustrating an example of a schematic configuration of a flight control apparatus 200 according to the first example embodiment;

FIG. 4 is a diagram illustrating a specific example of a plurality of zones 41, each of which being identified by latitude, longitude, and altitude as a three-dimensional space in common among mobile communication carrier networks 2 to a flight airspace 40 managed by the management apparatus 100;

FIG. 5 is a diagram illustrating an example of a flow of processing for the management apparatus 100 to collect information on traffic in each of the mobile communication carrier networks;

FIG. 6 is a diagram illustrating a first specific example of a flow of processing in which a flight path is configured in response to a flight permission request by a mobile terminal 3a;

FIG. 7 is an explanatory diagram for describing an example of flight operation of the mobile terminal 3a based on flight path information configured for the mobile terminal 3a;

FIG. 8 is a diagram illustrating a second specific example of a flow of processing in which a radio resource is configured for each of radio stations in response to the flight permission request by the mobile terminal 3a;

FIG. 9 is a diagram illustrating an example of a flow of processing in which the mobile terminal 3a performs a flight according to the flight path in the second specific example;

FIG. 10 is a diagram for describing a flow of processing based on instruction of flight cancellation from the management apparatus 100;

FIG. 11 is a diagram for describing a flow of processing of starting communication between mobile terminals;

FIG. 12 is a diagram illustrating a specific example in which an AMF 1201 distributes different tracking area lists to two different mobile terminals 1202 and 1203; and

FIG. 13 is an explanatory diagram illustrating an example of a schematic configuration of a system 5 according to a second example embodiment.

### DESCRIPTION OF THE EXAMPLE EMBODIMENTS

Hereinafter, example embodiments of the present invention will be described in detail with reference to the accompanying drawings. Note that, in the Specification and drawings, elements to which similar descriptions are applicable are denoted by the same reference signs, and overlapping descriptions may hence be omitted.

Descriptions will be given in the following order.
1. Overview of Example Embodiments of Present Invention
2. Configuration of System 1
3. First Example Embodiment
   3.1. Configuration of Management Apparatus 100
   3.2. Configuration of Flight Control Apparatus 200
   3.3. Technical Features
4. Second Example Embodiment
   4.1. Configuration of System 5
   4.2. Configuration of Management Apparatus 500
   4.3. Configuration of Control Apparatus 600
   4.4. Technical Features
5. Other Example Embodiments

### 1. Overview of Example Embodiment of Present Invention

First, an overview of example embodiments of the present invention will be described.

### (1) Technical Issues

Mobile terminals (drone or the like) that perform flight according to information on a flight path received from a server or the like via a communication network have been widely known.

For example, PTL 1 discloses a configuration of allocating a flight airspace and a flight permission period to a drone based on flight scheduled information transmitted from each business terminal, and when there is predetermined commonality in flight airspaces and flight directions of a plurality of drones, causing sharing of the flight airspaces on the condition that the plurality of drones perform formation flight.

Further, PTL 2 discloses a configuration of, when an allocation request of a flight airspace of a drone is received from a plurality of business operators, allocating the flight airspace with a business operator having high priority based on past performance of allocation of each business operator being prioritized over other business operators.

In addition, PTL 3 discloses a configuration in which an unmanned aircraft (UAV) moves ahead in accordance with a plan via a wireless communication network, and cells of the wireless communication network through which the UAV is to pass and time at which these cells are to be passed through are defined.

The above-described mobile terminals such as a drone and a UAV perform communication with a management apparatus that performs management of a flight via any mobile communication carrier network. Thus, for example, it is assumed that each of a plurality of mobile terminals flying near each other performs wireless communication with mobile communication carrier networks different from each other.

However, for example, in the technologies disclosed in PTLs 1 to 3, for example, when a plurality of mobile terminals as described above respectively perform wireless communication with mobile communication carrier networks different from each other, the flight of each of the mobile terminals cannot be appropriately managed.

One example object of the present example embodiment is to enable appropriate support of a flight of a mobile terminal that performs wireless communication with a mobile communication carrier network.

### (2) Technical Features

In the present example embodiment, for example, a management apparatus allocates a plurality of zones, each of which being identified by latitude, longitude, and altitude as a three-dimensional space in common among a plurality of mobile communication carrier networks, to a flight airspace allowing a plurality of mobile terminals to be flown, the plurality of mobile terminals respectively performing wireless communication with the plurality of mobile communication carrier networks, and transmits information on allocation of the plurality of zones to the mobile communication carrier networks respectively managed by the plurality of mobile communication carriers.

In the present example embodiment, for example, a control apparatus receives, from a management apparatus managing a plurality of zones, information on allocation of the plurality of zones allocated to a flight airspace allowing a plurality of mobile terminals to be flown, the plurality of mobile terminals respectively performing wireless communication with a plurality of mobile communication carrier networks, the information being the information on the allocation of the plurality of zones, each of which being identified by latitude, longitude, and altitude as a three-dimensional space in common among the plurality of mobile communication carrier networks, and performs processing for one or more first mobile terminals that perform wireless communication with a first mobile communication carrier network, based on the information on the allocation of the plurality of zones.

With this configuration, for example, a flight of a mobile terminal that performs wireless communication with a mobile communication carrier network can be appropriately supported.

Note that the technical features described above are merely a specific example of the example embodiments of the present invention, and as a matter of course, the example embodiments of the present invention are not limited to the technical features described above.

### 2. Configuration of System 1

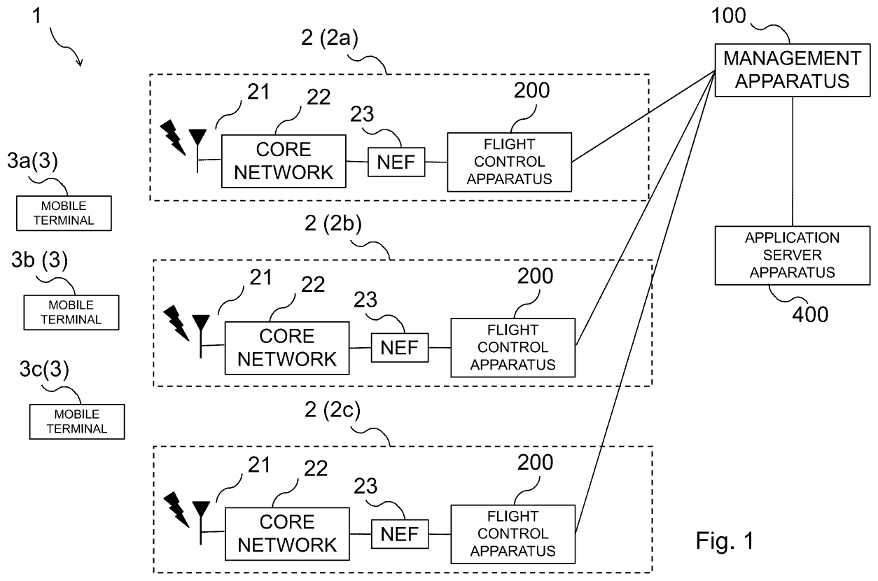

With reference to FIG. 1, an example of a configuration of a system 1 according to the example embodiments of the present invention will be described. FIG. 1 is an explanatory diagram illustrating an example of a schematic configuration of the system 1 according to the example embodiment of the present invention. With reference to FIG. 1, the system 1 includes a management apparatus 100, mobile communication carrier networks 2a, 2b, and 2c (collectively referred to as “mobile communication carrier network 2”), mobile terminals 3a, 3b, and 3c (collectively referred to as “mobile terminal 3”), and an application server apparatus 400.

### (Management Apparatus 100)

The management apparatus 100 is a network node located outside of the mobile communication carrier network 2, and for example, performs communication with the mobile terminal 3 via the mobile communication carrier network 2.

### (Mobile Communication Carrier Network 2)

The mobile communication carrier networks 2a, 2b, and 2c are each a network managed by a domain of their respective mobile communication carriers. The mobile communication carrier networks 2a, 2b, and 2c each include a radio access network 21, a core network 22, a network exposure function (NEF) 23, a flight control apparatus 200, and the like.

The mobile communication carrier network 2 is, for example, a network conforming to standards/specifications of the Third Generation Partnership Project (3GPP). More specifically, for example, the mobile communication carrier network 2 may be a network conforming to standards/specifications of LTE/LTE-Advanced and/or System Architecture Evolution (SAE). Alternatively, the mobile communication carrier network 2 may be a network conforming to standards/specifications of the fifth generation (5G)/New Radio (NR). In the mobile communication carrier network 2, with the use of the radio access network 310, wireless communication can be performed with the mobile terminal 3.

The NEF 23 performs, for example, association between an identification number of the mobile terminal 3 recognized by the management apparatus 100 and a subscriber identifier in the mobile communication carrier.

### (Mobile Terminal 3)

The mobile terminal 3 is, for example, a drone or an unmanned aircraft (UAV) used for the purpose of a delivery service, a taxi, or the like, and is, for example, a terminal apparatus that performs a flight according to information on the flight received from the management apparatus 100, the flight control apparatus 200, or the like. For example, each of the mobile terminals 3a, 3b, and 3c performs communication with one of the mobile communication carrier networks 2a, 2b, and 2c. In the following, as a specific example, the mobile terminal 3a performs communication with the mobile communication carrier network 2a, the mobile terminal 3b performs communication with the mobile communication carrier network 2b, and the mobile terminal 3c performs communication with the mobile communication carrier network 2c.

Each of the mobile terminals 3 stores a globally unique specific individual identification number. The number may be a Generic Public Subscription Identifier (GPSI). The specific individual identification number of each of the mobile terminals 3 may be converted into a specific number managed in the mobile communication carrier network 2 in the NEF 23 described above. The specific number in the mobile communication carrier network 2 may be a Subscription Concealed Identifier (SUCI), a Subscription Permanent Identifier (SUPI), a 5G Globally Unique Temporary Identifier (5G-GUTI), a 5G S-Temporary Mobile Subscription Identifier (5G-S-TMSI), a Globally Unique Temporary Identifier (GUTI), or an S-Temporary Mobile Subscription Identifier (S-TMSI).

### (Application Server Apparatus 400)

The application server apparatus 400 provides various pieces of information to the management apparatus 100. For example, the application server apparatus 400 may, for example, acquire weather information of a flight airspace managed by the management apparatus 100 and provide the weather information to the management apparatus 100 at any timing. Note that the application server apparatus 400 may, for example, communicate with the flight control apparatus 200 in each of the mobile communication carrier networks 2a, 2b, and 2c. In this case, for example, the application server apparatus 400 may execute a flight application for a business operator (a delivery business operator, a taxi business operator, or the like) managed by the mobile terminal 3 to perform remote operation. The application server apparatus 400 may communicate with the management apparatus 100 via the Internet.

### 3. First Example Embodiment

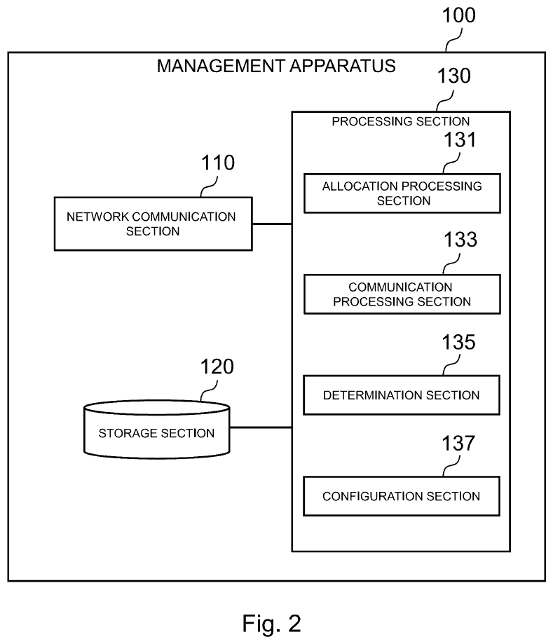

Next, with reference to FIG. 2 to FIG. 12, a first example embodiment of the present invention will be described.

### <3.1. Configuration of Management Apparatus 100>

Next, with reference to FIG. 2, an example of a configuration of the management apparatus 100 according to the first example embodiment will be described. FIG. 2 is a block diagram illustrating an example of a schematic configuration of the management apparatus 100 according to the first example embodiment. With reference to FIG. 2, the management apparatus 100 includes a network communication section 110, a storage section 120, and a processing section 130.

### (1) Network Communication Section 110

The network communication section 110 receives a signal from a network and transmits a signal to the network.

### (2) Storage Section 120

The storage section 120 temporarily or permanently stores a program (instructions) and parameters for operations of the management apparatus 100 as well as various data. The program includes one or more instructions for the operations of the management apparatus 100.

### (3) Processing Section 130

The processing section 130 provides various functions of the management apparatus 100. The processing section 130 includes an allocation processing section 131, a communication processing section 133, a determination section 135, and a configuration section 137. Note that the processing section 130 may further include constituent elements other than these constituent elements. In other words, the processing section 130 may also perform operations other than the operations of these constituent elements. Specific operations of the allocation processing section 131, the communication processing section 133, the determination section 135, and the configuration section 137 will be described later in detail.

For example, the processing section 130 (communication processing section 133) communicates with the mobile communication carrier network 2, the application server apparatus 400, and the like via the network communication section 110.

### (4) Implementation Example

The network communication section 110 may be implemented with a network adapter and/or a network interface card, and the like. The storage section 120 may be implemented with a memory (e.g., a nonvolatile memory and/or a volatile memory) and/or a hard disk, and the like. The processing section 130 may be implemented with one or more processors. The allocation processing section 131, the communication processing section 133, the determination section 135, and the configuration section 137 may be implemented with the same processor or may be implemented with separate processors. The memory (storage section 120) may be included in the one or more processors or may be provided outside the one or more processors.

The management apparatus 100 may include a memory configured to store a program (instructions) and one or more processors that can execute the program (instructions). The one or more processors may perform operations of the processing section 130 (operations of the allocation processing section 131, the communication processing section 133, the determination section 135, and/or the configuration section 137) by executing the program. The program may be a program for causing the processor(s) to execute the operations of the processing section 130 (operations of the allocation processing section 131, the communication processing section 133, the determination section 135, and/or the configuration section 137).

Note that the management apparatus 100 may be virtual. In other words, the management apparatus 100 may be implemented as a virtual machine. In this case, the management apparatus 100 (the virtual machine) may operate as a physical machine (hardware) including a processor, a memory, and the like, and a virtual machine on a hypervisor.

### <3.2. Configuration of Flight Control Apparatus 200>

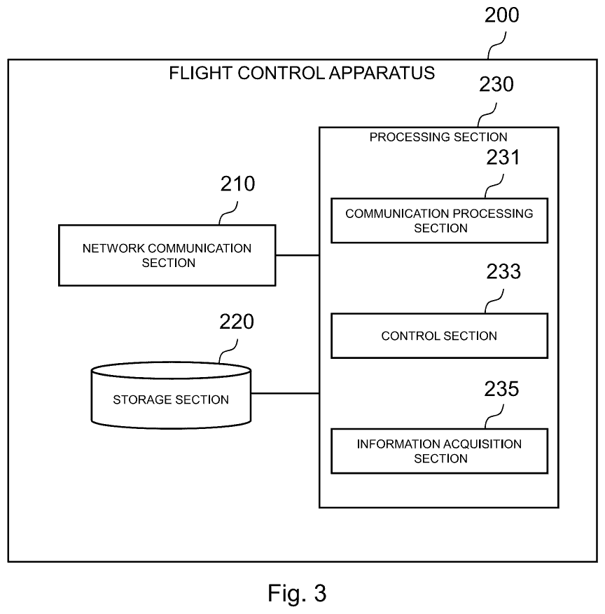

Next, with reference to FIG. 3, an example of a configuration of the flight control apparatus 200 according to the first example embodiment will be described. FIG. 3 is a block diagram illustrating an example of a schematic configuration of the flight control apparatus 200 according to the first example embodiment. With reference to FIG. 3, the flight control apparatus 200 includes a network communication section 210, a storage section 220, and a processing section 230.

### (1) Network Communication Section 210

The network communication section 210 receives a signal from a network and transmits a signal to the network.

### (2) Storage Section 220

The storage section 220 temporarily or permanently stores a program (instructions) and parameters for operations of the flight control apparatus 200 as well as various data. The program includes one or more instructions for the operations of the flight control apparatus 200.

### (3) Processing Section 230

The processing section 230 provides various functions of the flight control apparatus 200. The processing section 230 includes a communication processing section 231, a control section 233, and an information acquisition section 235. Note that the processing section 230 may further include constituent elements other than these constituent elements. In other words, the processing section 230 may also perform operations other than the operations of these constituent elements. Specific operations of the communication processing section 231, the control section 233, and the information acquisition section 235 will be described later in detail.

For example, the processing section 230 (communication processing section 231) communicates with the management apparatus 100 and the like via the network communication section 210.

### (4) Implementation Example

The network communication section 210 may be implemented with a network adapter and/or a network interface card, and the like. The storage section 220 may be implemented with a memory (e.g., a nonvolatile memory and/or a volatile memory) and/or a hard disk, and the like. The processing section 230 may be implemented with one or more processors. The communication processing section 231, the control section 233, and the information acquisition section 235 may be implemented with the same processor or may be implemented with separate processors. The memory (storage section 220) may be included in the one or more processors or may be provided outside the one or more processors.

The flight control apparatus 200 may include a memory configured to store a program (instructions) and one or more processors that can execute the program (instructions). The one or more processors may perform operations of the processing section 130 (operations of the communication processing section 231, the control section 233, and/or the information acquisition section 235) by executing the program. The program may be a program for causing the processor(s) to execute the operations of the processing section 130 (operations of the communication processing section 231, the control section 233, and/or the information acquisition section 235).

Note that the flight control apparatus 200 may be virtual. In other words, the flight control apparatus 200 may be implemented as a virtual machine. In this case, the flight control apparatus 200 (the virtual machine) may be a physical machine (hardware) including a processor, a memory, and the like, and a virtual machine on a hypervisor.

### <3.3. Technical Features>

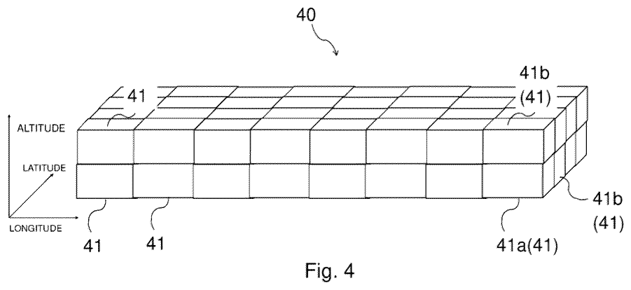

With reference to FIG. 4 to FIG. 12, technical features of the first example embodiment will be described.

According to the first example embodiment, the management apparatus 100 (allocation processing section 131) allocates a plurality of zones, each of which being identified by latitude, longitude, and altitude as a three-dimensional space in common among the plurality of mobile communication carrier networks 2 to a flight airspace allowing the plurality of mobile terminals 3 to be flown, the plurality of mobile terminals 3 respectively performing wireless communication with the plurality of mobile communication carrier networks 2. The management apparatus 100 (communication processing section 133) transmits information on allocation of the plurality of zones to the mobile communication networks respectively managed by the plurality of mobile communication carriers.

According to the first example embodiment, the flight control apparatus 200 (communication processing section 231) receives, from the management apparatus 100 managing a plurality of zones, information on allocation of the plurality of zones allocated to a flight airspace allowing the plurality of mobile terminals 3 to be flown, the plurality of mobile terminals 3 respectively performing wireless communication with the plurality of mobile communication carrier networks 2, the information being the information on the allocation of the plurality of zones, each of which being identified by latitude, longitude, and altitude as a three-dimensional space in common among the plurality of mobile communication carrier networks 2. The flight control apparatus 200 (control section 233) performs processing for one or more first mobile terminals (for example, the mobile terminal 3a) that perform wireless communication with a first mobile communication carrier network (for example, the mobile communication carrier network 2a), based on the information on the allocation of the plurality of zones.

### (1) Information on Allocation of Plurality of Zones

FIG. 4 is a diagram illustrating a specific example of a plurality of zones 41, each of which being identified by latitude, longitude, and altitude as a three-dimensional space in common among the plurality of mobile communication carrier networks 2, the plurality of zones 41 being allocated to a flight airspace 40 managed by the management apparatus 100. With reference to FIG. 4, each of the plurality of zones 41 is, for example, a three-dimensional space identified by latitude, longitude, and altitude. As a specific example, a region in which the flight airspace 40 is identified with (X+3) minutes from 35 degrees X minutes north latitude, (Y+7) minutes from 139 degrees Y minutes east longitude, and altitude of 150 m or less is assumed (X and Y are any positive number). In this case, for example, the management apparatus 100 allocates a total of 64 zones. In other words, four different zones are allocated in the unit of minutes in the latitude direction, eight different zones are allocated in the unit of minutes in the longitude direction, and two different zones are allocated in the unit of 75 m in the altitude direction.

For example, a zone 41a at 35 degrees X minutes north latitude, 139 degrees (Y+7) minutes east longitude, and altitude of 0 to 75 m is considered. In this case, adjacent zones in the latitude direction and the altitude direction correspond to zones 41b and 41c, respectively.

The example illustrated in FIG. 4 as described above is considered. In this case, as information on the allocation of the plurality of zones, the management apparatus 100 transmits information on the flight airspace 40 identified with latitude, longitude, and altitude, the number (for example, 64) of zones allocated in the flight airspace 40, and an allocation standard (the unit of minutes, the unit of the altitude of 75 m, or the like) to each of the each of the mobile communication carrier networks 2.

As the information on the allocation of the plurality of zones, the management apparatus 100 may transmit information (identifiers of the zones or the like) for identifying each of the zones 41 in the flight airspace 40 to each of the mobile communication carrier networks 2.

For example, the identifier of the zone may be expressed by a value defined for each of latitude, longitude, and altitude. To apply this to the example as illustrated in FIG. 4, the latitude direction is expressed by a value of 2 bits, the longitude direction is expressed by a value of 3 bits, and the altitude direction is expressed by a value of 1 bit. For example, the identifier of the zone 41a is expressed by 0011100 in the order of latitude, longitude, and altitude, the identifier of the zone 41b is expressed by 0111100 in the order of latitude, longitude, and altitude, and the identifier of the zone 41c is expressed by 0011101 in the order of latitude, longitude, and altitude.

In this manner, in each of the mobile communication carrier networks 2, the flight control apparatus 200 can appropriately manage the flight of the mobile terminal 3 performing communication with each of the mobile communication carrier networks 2, based on the plurality of zones.

### (2) Association Between Plurality of Zones and Area Identifiers

For example, a case in which the flight control apparatus 200 is a network node in the first mobile communication carrier network (for example, the mobile communication carrier network 2a) is assumed. In this case, the flight control apparatus 200 (control section 233) may perform processing for associating each of the plurality of zones and one or more area identifiers in the first mobile communication carrier network (for example, the mobile communication carrier network 2a), based on the information on the allocation of the plurality of zones.

Specifically, the one or more area identifiers in the first mobile communication carrier network (for example, the mobile communication carrier network 2a) are each an identifier of a tracking area configured in the first mobile communication carrier network (for example, the mobile communication carrier network 2a). For example, one zone may be associated with one tracking area. One zone may be associated with a plurality of tracking areas. A plurality of zones may be associated with one tracking area.

For example, as described above, when the identifier of the zone is expressed by a value defined for each of latitude, longitude, and altitude, the identifier of the zone may be a part of the identifier of the tracking area. For example, when a plurality of tracking areas are associated with the zone 41a as illustrated in FIG. 4, the identifier of each of the tracking areas may be expressed by (0011100) being an identifier of the zone 41a and a bit string for distinguishing other tracking areas.

The one or more area identifiers in the first mobile communication carrier network (for example, the mobile communication carrier network 2a) are not limited to the identifier(s) of the tracking area(s) as described above, and may be identifier(s) for identifying one or more cells included in the first mobile communication carrier network (for example, the mobile communication carrier network 2a), or a radio station or a sector that accommodates one or more cells. For example, one zone may be associated with a set of a plurality of base stations. With reference to FIG. 4 specifically, the zone 41a may be associated with both of two base stations A and B adjacent to each other in the mobile communication carrier network 2a. A plurality of zones may be associated with one base station or sector.

### (2-1) Example of Information Collection Using Zone(s)

For example, the flight control apparatus 200 (information acquisition section 235) included in the first mobile communication carrier network (for example, the mobile communication carrier network 2a) acquires information on traffic in an area (for example, a cell) identified with the one or more area identifiers (for example, identifier(s) of cell(s)) in the first mobile communication carrier network (for example, the mobile communication carrier network 2a).

Next, the flight control apparatus 200 (information acquisition section 235) generates information on traffic in one or more zones associated with the one or more area identifiers, according to the information on the traffic. Here, the information on the traffic in the one or more zones is, for example, a total value of traffic in each of the cell(s) associated with the one or more zones.

Next, the flight control apparatus 200 (communication processing section 231) transmits the information on the traffic in the one or more zones to the management apparatus 100.

### Flow of Processing

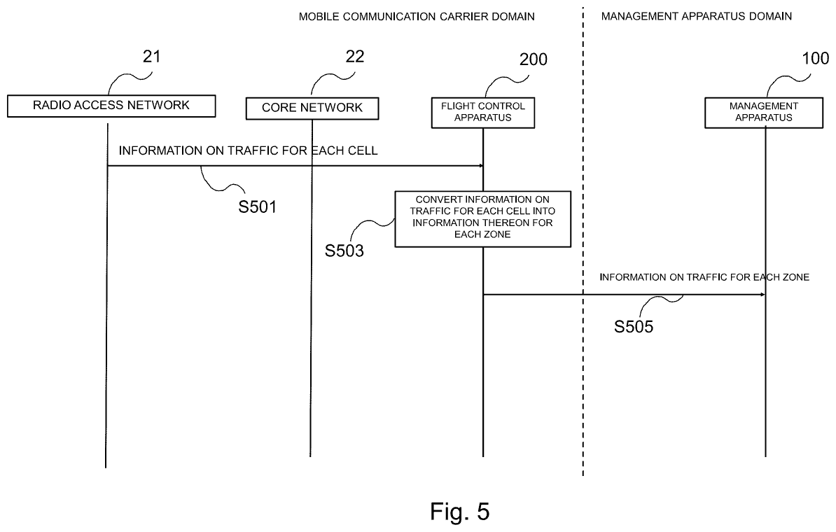

FIG. 5 is a diagram illustrating an example of a flow of processing for the management apparatus 100 to collect information on traffic in each of the mobile communication carrier networks.

With reference to FIG. 5, in the radio access network 21, information on traffic for each cell is collected, and is transmitted to the flight control apparatus 200 via the core network 22 (S501). Here, the information on the traffic for each cell includes information indicating a traffic amount scheduled for each time frame and information pertaining to traffic (for example, a type of each of the mobile terminals existing in cell(s) or the like). Next, the flight control apparatus 200 (control section 233) converts the information on the traffic for each cell into information on traffic for each zone associated with each of the cells (S503). Next, the flight control apparatus 200 (communication processing section 231) transmits the information on the traffic for each zone to the management apparatus 100. As another processing example, the flight control apparatus 200 may manage information on traffic in all of the cells. In this case, the collection of the information on the traffic for each cell (S501) is not executed.

According to the processing illustrated in FIG. 5 described above, the management apparatus 100 can collect information on traffic in each of the mobile communication carrier networks 2 for each zone.

### (2-2) Management of Flight of Mobile Terminal

The management apparatus 100 (communication processing section 231) receives information on a flight plan of the first mobile terminal via the first mobile communication carrier network (for example, the mobile communication carrier network 2a). For example, the information on the flight plan of the first mobile terminal is transmitted from the flight control apparatus 200 in the first mobile communication carrier network (for example, the mobile communication carrier network 2a). Specifically, the information on the flight plan is a flight permission request performed by the first mobile terminal (for example, the mobile terminal 3a), and includes, for example, information indicating a departure point, a destination, departure scheduled time, a type of the first mobile terminal (for example, the mobile terminal 3a), and the like.

The management apparatus 100 (determination section 135) determines one or more zones through which the first mobile terminal passes out of the plurality of zones, based on the information on the flight plan of the one mobile terminal. More specifically, the management apparatus 100 (determination section 135) determines a first zone through which the first mobile terminal (for example, the mobile terminal 3a) passes in a first time frame out of the plurality of zones, based on the information on the flight plan of the first mobile terminal. In this manner, the zone (first zone) through which the first mobile terminal (for example, the mobile terminal 3a) passes in each of the time frames is determined. Then, information on one or more zones through which the first mobile terminal (for example, the mobile terminal 3a) passes is transmitted from the management apparatus 100 to the first mobile communication carrier network (for example, the mobile communication carrier network 2a) as flight path information of the first mobile terminal (for example, the mobile terminal 3a).

The flight control apparatus 200 (communication processing section 231) in the mobile communication carrier network 2 receives, from the management apparatus 100, information on the flight path including one or more zones in which the flight of the one or more first mobile terminals (for example, the mobile terminal 3a) is permitted. Then, the flight control apparatus 200 (control section 233) configures a radio resource for the flight of the one or more first mobile terminals (for example, the mobile terminal 3a), based on the information on the flight path including one or more zones in which the flight of the one or more first mobile terminals (for example, the mobile terminal 3a) is permitted.

### Flow of Processing

### (First Specific Example)

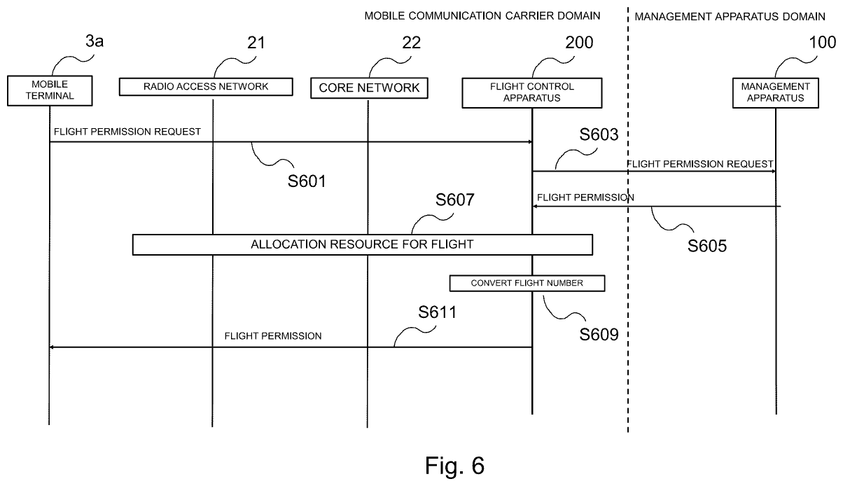

FIG. 6 is a diagram illustrating a first specific example of a flow of processing in which the flight path is configured in response to the flight permission request by the mobile terminal 3a.

With reference to FIG. 6, the mobile terminal 3a transmits a message of a flight permission request to the flight control apparatus 200 via the radio access network 21 and the core network 22 (S601). Here, the message of the flight permission request includes, as described above, information indicating a departure point, a destination, departure scheduled time, a type of the first mobile terminal (for example, the mobile terminal 3a), and the like.

Next, the flight control apparatus 200 transmits a message corresponding to the message of the flight permission request received from the mobile terminal 3a to the management apparatus 100 (S603).

Next, the management apparatus 100 creates a message of flight permission for the mobile terminal 3a in response to the message of the flight permission request received from the flight control apparatus 200, and transmits the message to the flight control apparatus 200 (S605). Here, the message of the flight permission for the mobile terminal 3a includes, for example, a departure point, a destination, a flight number for identifying the flight, permitted departure time, flight path information identified with one or more zones, and the like.

In determination of the flight permission performed by the management apparatus 100, a degree of congestion related to a flight scheduled zone is taken into consideration. The degree of congestion means a degree of congestion for traffic handled by all of the mobile communication carriers providing services to their zones. When the degree of congestion of a certain zone at certain time is too high to be granted permission for the flight, the management apparatus 100 may transmit a message of flight permission to the flight control apparatus 200, based on another alternative route (S605). Note that, when the management apparatus 100 cannot find another alternative route, the management apparatus 100 may transmit a message of flight disapproval including a reason indicating the flight disapproval due to the congestion for the message of the flight control apparatus 200.

In addition, in determination of the flight permission performed by the flight control apparatus 200, information received from the application server apparatus 400 may be taken into consideration. For example, in a case of bad weather such as a storm at the date and time of the flight plan received from the mobile terminal 3a and in a flying area, a message of flight disapproval including a reason indicating the flight disapproval due to the bad weather may be transmitted for the message of the flight control apparatus 200.

Next, the flight control apparatus 200 communicates with each of the core network 22 and the radio access network 21, and performs processing of allocating a resource for the flight of the mobile terminal 3a (S607).

Next, the flight control apparatus 200 converts the flight number received from the management apparatus 100 into a flight number capable of being identified in the mobile communication carrier network 2a (S609).

Next, the flight control apparatus 200 transmits a message of flight permission to the mobile terminal 3a (S611). Here, the message of the flight permission includes, for example, a departure point, a destination, a flight number capable of being identified in the mobile communication carrier network 2a, permitted departure time, a permitted flight path, and the like.

According to the processing illustrated in FIG. 6 described above, the flight path information identified by one or more zones can be configured for the flight permission request by the mobile terminal 3a.

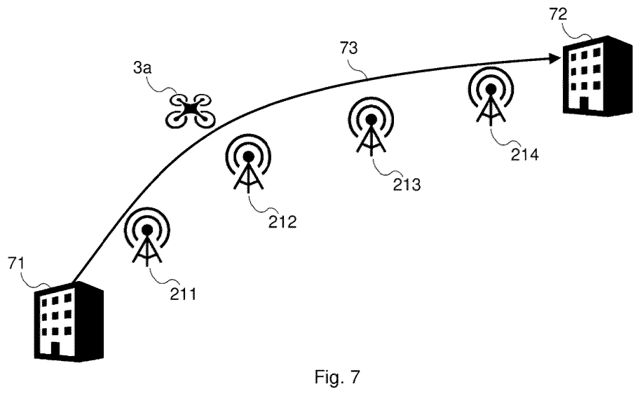

FIG. 7 is an explanatory diagram for describing an example of flight operation of the mobile terminal 3a based on the flight path information configured for the mobile terminal 3a. With reference to FIG. 7, for example, in S607 described above, the radio access network 21 allocates a radio resource for the mobile terminal 3a to fly along a flight path 73 to four radio stations 211, 212, 213, and 214 whose coverage areas are configured on the flight path 73 from a departure point 71 to a destination 72. The radio resource is, specifically, a frequency time domain resource allocated by each of the radio stations 211, 212, 213, and 214 to perform wireless communication with the mobile terminal 3a. For the mobile terminal 3a, each of the radio stations 211, 212, 213, and 214 allocates as many frequency time domain resources as necessary for the mobile terminal 3a to perform flight while the mobile terminal 3a exists in the coverage area, for example. In this manner, as illustrated in FIG. 7, the mobile terminal 3a transmits and/or receives information (for example, position information of the mobile terminal 3a, remaining battery information of the mobile terminal 3a, instruction information from the management apparatus 100, or the like) with the flight control apparatus 200 and the management apparatus 100 via each of the radio stations in order of the radio stations 211, 212, 213, and 214, and can thereby perform flight along the flight path 73.

### Second Specific Example

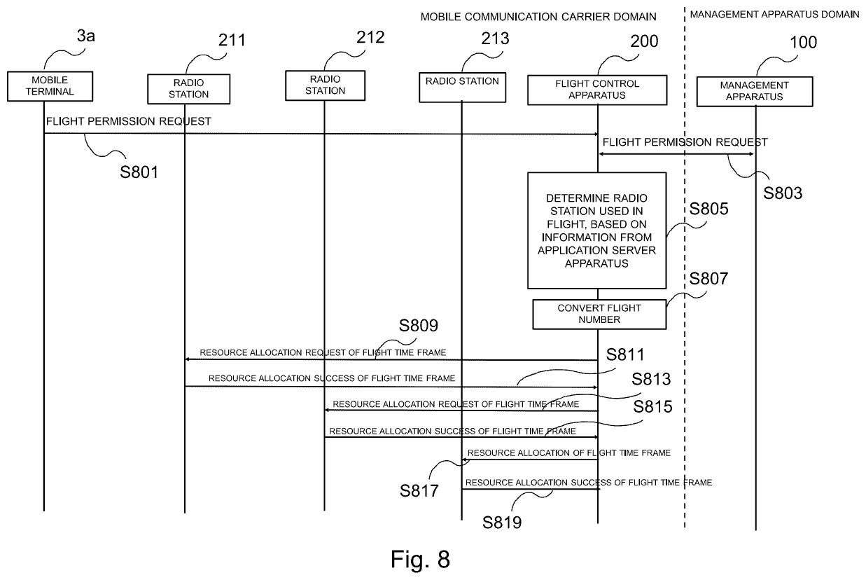

FIG. 8 is a diagram illustrating a second specific example of a flow of processing in which a radio resource is configured for each of the radio stations in response to the flight permission request by the mobile terminal 3a.

With reference to FIG. 8, the mobile terminal 3a transmits a message of a flight permission request to the flight control apparatus 200 (S801). Here, the message of the flight permission request includes, information indicating a departure point, a destination, departure scheduled time, a type of the first mobile terminal (for example, the mobile terminal 3a), and the like. In addition, the message of the flight permission request may include radio characteristics information of the mobile terminal 3a indicating which Radio Access Technology (RAT) and frequency band are supported, and flight characteristics information indicating maximum speed, highest altitude, flight possible time, wind resistance characteristics, and the like.

Next, the flight control apparatus 200 transmits a message corresponding to the message of the flight permission request received from the mobile terminal 3a to the management apparatus 100, and receives a message of flight permission for the mobile terminal 3a from the management apparatus 100 (S803). Here, the message of the flight permission for the mobile terminal 3a includes, for example, a departure point, a destination, a flight number for identifying the flight, permitted departure time, flight path information identified with one or more zones, and the like.

In determination of the flight permission performed by the management apparatus 100, a degree of congestion related to a flight scheduled zone is taken into consideration. The degree of congestion means a degree of congestion for traffic handled by all of the mobile communication carriers providing services to their zones. When the degree of congestion of a certain zone at certain time is too high to be granted permission for the flight, the management apparatus 100 may transmit a message of flight permission to the flight control apparatus 200, based on another alternative route. Note that, when the management apparatus 100 cannot find another alternative route, the management apparatus 100 may transmit a message of flight disapproval including a reason indicating the flight disapproval due to the congestion for the message of the flight control apparatus 200.

In addition, in determination of the flight permission performed by the flight control apparatus 200, information received from the application server apparatus 400 may be taken into consideration. For example, in a case of bad weather such as a storm at the date and time of the flight plan received from the mobile terminal 3a and in a flying area, a message of flight disapproval including a reason indicating the flight disapproval due to the bad weather may be transmitted for the message of the flight control apparatus 200.

Next, the flight control apparatus 200 determines a radio station used in the flight, based on the information from the application server apparatus 400, for example (S805). Specifically, the flight control apparatus 200 receives weather information from the application server apparatus 400, and for example, determines three radio stations 801, 802, and 803 whose coverage areas are configured on the flight path as the radio stations used in the flight for the mobile terminal 3a, in view of the degree of congestion of each radio station, capability of the mobile terminal 3a, weather forecast, and the like.

Next, the flight control apparatus 200 converts the flight number received from the management apparatus 100 into a flight number capable of being identified in the mobile communication carrier network 2a (S807).

Next, the flight control apparatus 200 transmits a message indicating a resource allocation request of a flight time frame to the radio station 211 (S809). Here, the message indicating the resource allocation request of the flight time frame includes, for example, an identifier capable of identifying the mobile terminal 3a in the mobile communication carrier network 2a and a flight number normalized for each mobile terminal. Next, the radio station 211 transmits a message indicating resource allocation success of the flight time frame to the flight control apparatus 200 (S811).

Next, the flight control apparatus 200 transmits a message indicating a resource allocation request of the flight time frame to the radio station 212 (S813). Here, the message indicating the resource allocation request of the flight time frame includes, for example, an identifier capable of identifying the mobile terminal 3a in the mobile communication carrier network 2a and a flight number normalized for each mobile terminal. Next, the radio station 212 transmits a message indicating resource allocation success of the flight time frame to the flight control apparatus 200 (S815).

Next, the flight control apparatus 200 transmits a message indicating a resource allocation request of the flight time frame to the radio station 213 (S817). Here, the message indicating the resource allocation request of the flight time frame includes, for example, an identifier capable of identifying the mobile terminal 3a in the mobile communication carrier network 2a and a flight number normalized for each mobile terminal. Next, the radio station 213 transmits a message indicating resource allocation success of the flight time frame to the flight control apparatus 200 (S819).

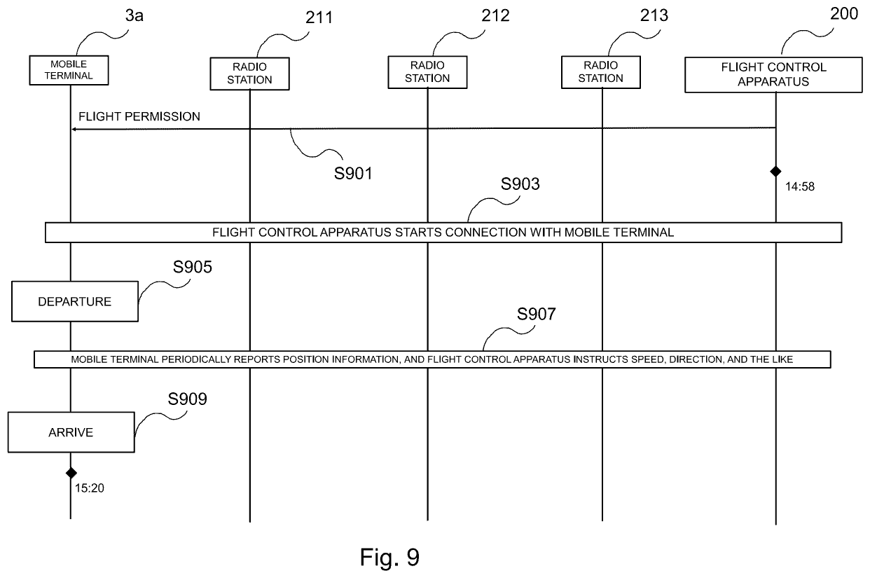

FIG. 9 is a diagram illustrating an example of a flow of processing in which the mobile terminal 3a performs a flight according to the flight path in the second specific example.

With reference to FIG. 9, first, the flight control apparatus 200 transmits a message indicating flight permission to the mobile terminal 3a (S901).

For example, when the time is past several minutes before departure time (for example, 14:58), the flight control apparatus 200 starts communication with the mobile terminal 3a (S903). Alternatively, the mobile terminal 3a may start communication with the flight control apparatus 200 (S903).

Next, when the time is the departure time (for example, 15:00), the mobile terminal 3a takes off from a departure point, and starts flight to a destination (S905).

Next, the mobile terminal 3a periodically reports current position information and the like to the flight control apparatus 200. The flight control apparatus 200 gives instruction related to the flight, such as the flight speed and the flight direction, for the mobile terminal 3a (S907).

Next, the mobile terminal 3a arrives at the destination before arrival scheduled time (for example, 15:20) (S909).

According to the processing illustrated in FIG. 8 and FIG. 9 described above, the flight control apparatus 200 can allocate a radio resource for the flight of the mobile terminal 3a for an appropriate radio station, in view of weather information, congestion of the radio station, a congestion state, and the like. In this manner, the mobile terminal 3a can securely perform the flight from the departure point to the destination.

(3) Management of Number of Mobile Terminals that Can Pass through Each of Zones

The management apparatus 100 (configuration section 137) may configure the number of mobile terminals permitted to pass in each of the time frames in each of the plurality of zones. For example, the management apparatus 100 may configure the number of mobile terminals permitted to pass in the zone in each of the time frames, according to the flight direction of each of the mobile terminals 3. The management apparatus 100 may reduce the number of mobile terminals permitted to pass in a night time frame, in comparison to that of mobile terminals permitted to pass in a daytime time frame. In this manner, the flight of the mobile terminal can be appropriately managed in the night time frame, when a visual flight is difficult. Regarding an area in which any flight of any mobile terminal is permitted, the management apparatus 100 (configuration section 137) may invariably configure the number of mobile terminals permitted in the zone to 0.

In addition, the management apparatus 100 (configuration section 137) may configure the number of mobile terminals permitted to pass in the zone in each of the time frames according to priority of the mobile terminals.

Specifically, the management apparatus 100 (communication processing section 133) receives information on a type of the first mobile terminal (for example, the mobile terminal 3a) via the first mobile communication carrier network (for example, the mobile communication carrier network 2a). Then, the management apparatus 100 (configuration section 137) may configure the number of second mobile terminals permitted to pass in the first time frame in the first zone, based on the information on the type of the first mobile terminal (for example, the mobile terminal 3a).

Here, the information on the type of the first mobile terminal (for example, the mobile terminal 3a) corresponds to, for example, an attribute classified according to an application (a delivery service, a taxi) or the like of the mobile terminal. As an example, when the type of the first mobile terminal (mobile terminal 3a) is the delivery service, the management apparatus 100 (configuration section 137) configures the number of second mobile terminals permitted to pass in the first time frame in the first zone to 9. In other words, a total number of mobile terminals permitted to pass in the first time frame in the first zone is configured to 10. In contrast, when the type of the first mobile terminal (mobile terminal 3a) is the taxi, the management apparatus 100 (configuration section 137) configures the number of second mobile terminals permitted to pass in the first time frame in the first zone to 0. In other words, a total number of mobile terminals permitted to pass in the first time frame in the first zone is configured to 1.

### (4) Notification of Instruction Information of Flight Cancellation

The flight control apparatus 200 (communication processing section 231) may further receive information instructing cancellation of the flight in the first zone from the management apparatus 100. In this case, the flight control apparatus 200 (control section 233) may notify one or more mobile terminals present in the area identified with one or more area identifiers associated with the first zone of the information instructing cancellation of the flight.

More specifically, the information instructing cancellation of the flight is included in a Public Warning System (PWS) notification or a broadcast message of a Cell Broadcast Service (CBS).

### Flow of Processing

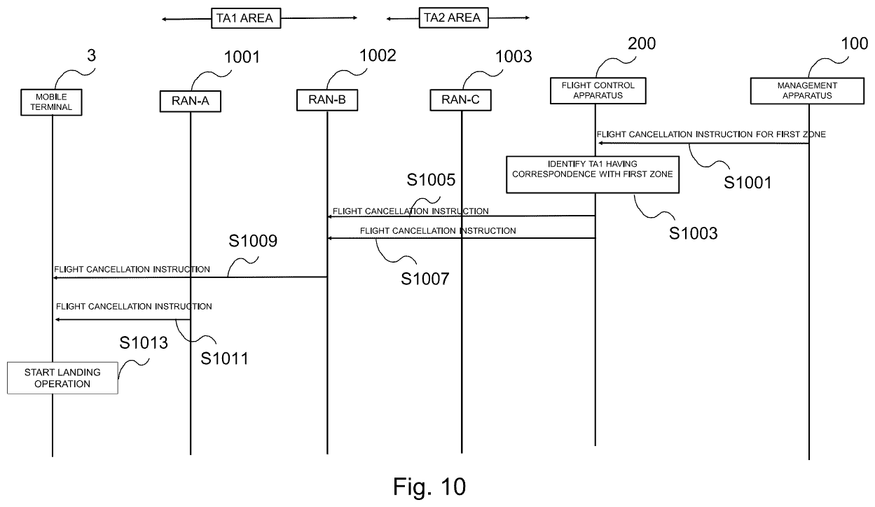

FIG. 10 is a diagram for describing a flow of processing based on instruction of flight cancellation from the management apparatus 100. In the example illustrated in FIG. 10, a first tracking area includes radio access networks 1001 and 1002, and a second tracking area includes a radio access network 1003.

With reference to FIG. 10, first, the management apparatus 100 recognizes that it is hailing in the first zone based on weather information from the application server apparatus 400, for example, and transmits a message of flight cancellation instruction for the first zone to the flight control apparatus 200 (S1001).

Next, the flight control apparatus 200 converts into an area identifier (for example, an identifier of the first tracking area) having correspondence with the first zone, with reference to correspondence between each of the plurality of zones and the one or more area identifiers (S1003).

Next, the flight control apparatus 200 transmits, to (the radio station) of the radio access networks 1001 and 1002 included in the first tracking area, a message corresponding to the message of the flight cancellation instruction from the management apparatus 100 (S1005 and 1007).

Next, (the radio station) of the radio access networks 1001 and 1002 included in the first tracking area notifies all of the mobile terminals 3 existing in the first tracking area of the message of the flight cancellation instruction (S1009 and S1011). Next, each of the mobile terminals 3 existing in the first tracking area starts landing operation, according to the message of the flight cancellation instruction from the radio station (S1013).

According to the processing illustrated in FIG. 10 described above, the flight control apparatus 200 can instruct flight cancellation only to the first tracking area corresponding to the zone in which flight cancellation is necessary. For example, the flight control apparatus 200 can be arranged not to perform unnecessary flight cancellation for the second tracking area in which flight cancellation is not necessary.

### (Inter-Terminal Communication During Landing Operation)

For example, two or more mobile terminals performing landing operation in the same tracking area may perform inter-terminal communication. Owing to such inter-terminal communication, a situation in which two or more mobile terminals collide with each other can be avoided.

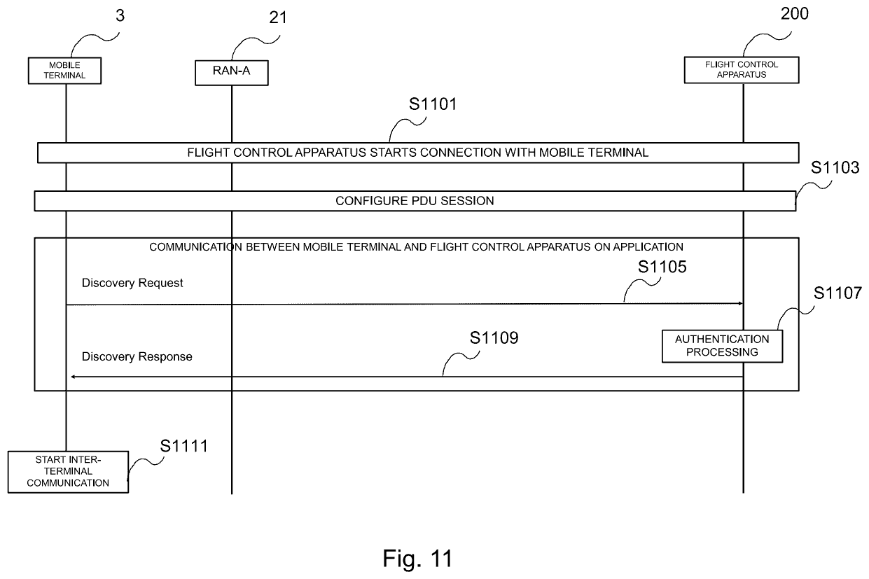

FIG. 11 is a diagram for describing a flow of processing of starting communication between mobile terminals.

With reference to FIG. 11, the flight control apparatus 200 starts connection with the mobile terminal 3 (S1101). Next, through communication between the flight control apparatus 200 and the mobile terminal 3, a PDU session is configured (S1103).

Next, the mobile terminal 3 transmits a message of a discovery request for inter-terminal communication with a neighboring mobile terminal 3 to the flight control apparatus 200 (S1105). For example, the message of the discovery request includes identification information of the neighboring mobile terminal 3, information on the flight path, and the like. Next, the flight control apparatus 200 performs authentication processing in response to the discovery request (S1107), and when the flight control apparatus 200 succeeds in authentication, the flight control apparatus 200 transmits a message of discovery response to the mobile terminal 3 (S1109). Subsequently, the mobile terminal 3 starts inter-terminal communication with the neighboring mobile terminal 3 (S1111). In this manner, owing to the inter-terminal communication between the mobile terminals 3, for example, with the current position information being transmitted and/or received to and from each other, secure landing can be achieved while avoiding collision.

### (5) Distribution of Activation Points of Position Registration Processing

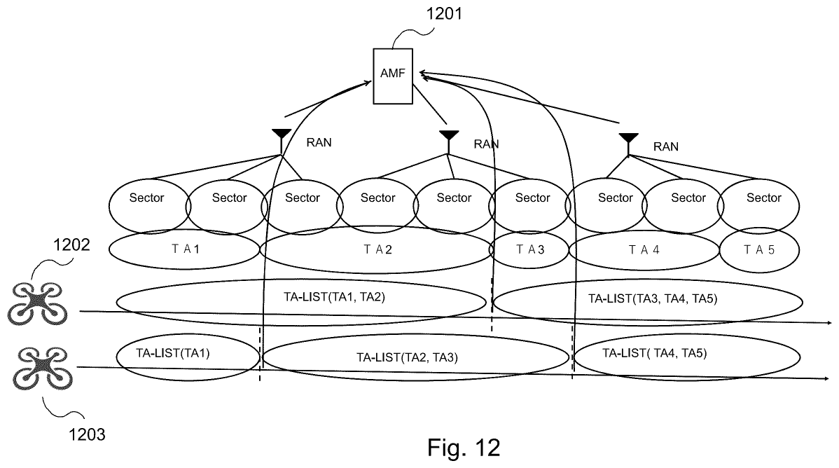

A node (for example, an access and mobility management function (AMF)) of the core network 22 included in the mobile communication carrier network 2 may distribute tracking area lists containing a plurality of tracking areas to each of the mobile terminals 3, and manage position registration. FIG. 12 is a diagram illustrating a specific example in which an AMF 1201 distributes different tracking area lists to two different mobile terminals 1202 and 1203.

According to the example illustrated in FIG. 12, both of the mobile terminals 1202 and 1203 perform a flight substantially in the same time frame according to the flight path in accordance with order of tracking areas TA1, TA2, TA3, TA4, and TA5. In this case, to the mobile terminal 1202, a tracking area list including the tracking areas TA1 and TA2 and a tracking area list including the tracking areas TA3, TA4, and TA5 are distributed. To the mobile terminal 1203, a tracking area list including the tracking area TA1, a tracking area list including the tracking areas TA2 and TA3, and a tracking area list including the tracking areas TA4 and TA5 are distributed.

With the tracking area lists distributed to the mobile terminals 1202 and 1203 being different in this manner, the mobile terminals 1202 and 1203 start position registration processing with the AMF 1201 at timings different from each other. In other words, according to the example illustrated in FIG. 12, congestion of control signals can be reduced by performing distribution of activation points of position registration signal processing.

### 4. Second Example Embodiment

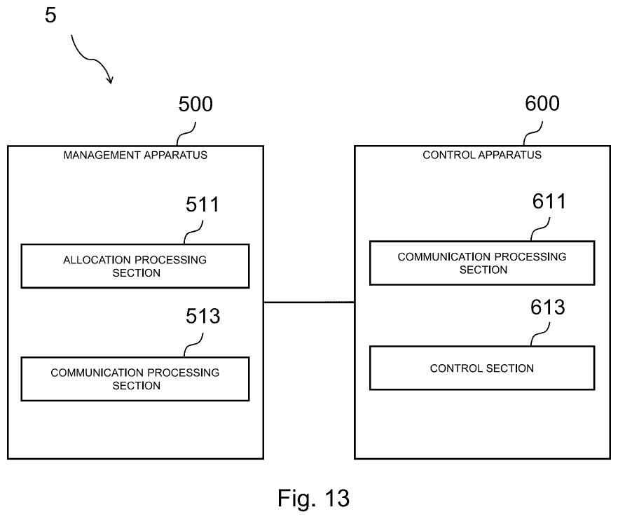

Next, with reference to FIG. 13, a second example embodiment of the present invention will be described. The above-described first example embodiment is a concrete example embodiment, whereas the second example embodiment is a more generalized example embodiment.

### <4.1. Configuration of System 5>

With reference to FIG. 13, an example of a configuration of a system 5 according to the second example embodiment will be described.

FIG. 13 is an explanatory diagram illustrating an example of a schematic configuration of the system 5 according to the second example embodiment. With reference to FIG. 13, the system 5 includes a management apparatus 500 and a control apparatus 600.

### <4.2. Configuration of Management Apparatus 500>

With reference to FIG. 13, the management apparatus 500 includes an allocation processing section 511 and a communication processing section 513. Specific operations of the allocation processing section 511 and the communication processing section 513 will be described later.

The allocation processing section 511 and the communication processing section 513 may be implemented with one or more processors, and a memory (e.g., a nonvolatile memory and/or a volatile memory), and/or a hard disk. The allocation processing section 511 and the communication processing section 513 may be implemented with the same processor or may be implemented with separate processors. The memory may be included in the one or more processors or may be provided outside the one or more processors.

The management apparatus 500 may include a memory configured to store a program (instructions) and one or more processors that can execute the program (instructions). The one or more processors may perform operations of the allocation processing section 511 and the communication processing section 513 by executing the program. The program may be a program for causing the processor(s) to execute the operations of the allocation processing section 511 and the communication processing section 513.

### <4.3. Configuration of Control Apparatus 600>

With reference to FIG. 13, the control apparatus 600 includes a communication processing section 611 and a control section 613. Specific operations of the communication processing section 611 and the control section 613 will be described later.

The communication processing section 611 and the control section 613 may be implemented with one or more processors, and a memory (e.g., a nonvolatile memory and/or a volatile memory), and/or a hard disk. The communication processing section 611 and the control section 613 may be implemented with the same processor or may be implemented with separate processors. The memory may be included in the one or more processors or may be provided outside the one or more processors.

The control apparatus 600 may include a memory configured to store a program (instructions) and one or more processors that can execute the program (instructions). The one or more processors may perform operations of the communication processing section 611 and the control section 613 by executing the program. The program may be a program for causing the processor(s) to execute the operations of the communication processing section 611 and the control section 613.

### <4.4. Technical Features>

Technical features of the according to the second example embodiment will be described.

According to the second example embodiment, the management apparatus 500 (allocation processing section 511) allocates a plurality of zones, each of which being identified by latitude, longitude, and altitude as a three-dimensional space in common among a plurality of mobile communication carrier networks, to a flight airspace allowing a plurality of mobile terminals to be flown, the plurality of mobile terminals respectively performing wireless communication with the plurality of mobile communication carrier networks. The management apparatus 500 (communication processing section 513) transmits the information on the allocation of the plurality of zones to a mobile communication network respectively managed by the plurality of mobile communication carriers.

According to the second example embodiment, the control apparatus 600 (communication processing section 611) receives, from the management apparatus 500 managing a plurality of zones information on allocation of the plurality of zones allocated to a flight airspace allowing a plurality of mobile terminals to be flown, the plurality of mobile terminals respectively performing wireless communication with a plurality of mobile communication carrier networks, the information being the information on the allocation of the plurality of zones, each of which being identified by latitude, longitude, and altitude as a three-dimensional space in common among the plurality of mobile communication carrier networks. The control apparatus 600 (control section 613) performs processing for one or more first mobile terminals performing wireless communication with a first mobile communication carrier network, based on the information on the allocation of the plurality of zones.

Relationship with First Example Embodiment

As an example, the management apparatus 500 and the control apparatus 600 of the second example embodiment are the management apparatus 100 and the flight control apparatus 200 of the first example embodiment, respectively. In this case, description regarding the first example embodiment may also be applied to the second example embodiment.

Note that the second example embodiment is not limited to this example.

The second example embodiment has been described above. According to the second example embodiment, a flight of a mobile terminal that performs wireless communication with a mobile communication carrier network can be appropriately supported.

### 5. Other Example Embodiments

Descriptions have been given above of the example embodiments of the present invention. However, the present invention is not limited to these example embodiments. It should be understood by those of ordinary skill in the art that these example embodiments are merely examples and that various alterations are possible without departing from the scope and the spirit of the present invention.

For example, the steps in the processing described in the Specification may not necessarily be executed in time series in the order described in the corresponding sequence diagram. For example, the steps in the processing may be executed in an order different from that described in the corresponding sequence diagram or may be executed in parallel. Some of the steps in the processing may be deleted, or more steps may be added to the processing.

An apparatus (e.g., one or more apparatuses (or units) out of plurality of apparatuses (or units) constituting the management apparatus, or a module for one of the plurality of apparatuses (or units)) including constituent elements (e.g., the allocation processing section, the communication processing section, the determination section, and/or the configuration section) of the management apparatus described in the Specification may be provided. An apparatus (e.g., a module for the terminal apparatus) including constituent elements (e.g., the communication processing section, the control section, and/or the information acquisition section) of the flight control apparatus described in the Specification may be provided. Moreover, methods including processing of the constituent elements may be provided, and programs for causing a processor to execute processing of the constituent elements may be provided. Moreover, non-transitory computer readable recording media (non-transitory computer readable media) having recorded thereon the programs may be provided. It is apparent that such apparatuses, modules, methods, programs, and non-transitory computer readable recording media are also included in the present invention.

The whole or part of the example embodiments disclosed above can be described as in the following supplementary notes, but are not limited to the following.

### (Supplementary Note 1)

A management apparatus including:
an allocation processing section configured to allocate a plurality of zones, each of which being identified by latitude, longitude, and altitude as a three-dimensional space in common among a plurality of mobile communication carrier networks to a flight airspace allowing a plurality of mobile terminals to be flown, the plurality of mobile terminals being configured to respectively perform wireless communication with the plurality of mobile communication carrier networks; and
a communication processing section configured to transmit information on allocation of the plurality of zones to the plurality of mobile communication carrier networks.

### (Supplementary Note 2)

The management apparatus according to supplementary note 1, wherein
the communication processing section is configured to receive information on a flight plan of a first mobile terminal via a first mobile communication carrier network.

### (Supplementary Note 3)

The management apparatus according to supplementary note 2, further including
a determination section configured to determine one or more zones through which the first mobile terminal passes out of the plurality of zones, based on the information on the flight plan of the first mobile terminal.

### (Supplementary Note 4)

The management apparatus according to supplementary note 3, wherein
the determination section is configured to determine a first zone through which the first mobile terminal passes in a first time frame out of the plurality of zones, based on the information on the flight plan of the first mobile terminal.

### (Supplementary Note 5)

The management apparatus according to supplementary note 4, further including:
a configuration section configured to configure a number of mobile terminals permitted to pass in each time frame for each of the plurality of zones.

### (Supplementary Note 6)

The management apparatus according to supplementary note 5, wherein
the communication processing section is configured to further receive information on a type of the first mobile terminal via the first mobile communication carrier network, and
the configuration section is configured to configure a number of second mobile terminals permitted to pass in the first time frame in the first zone, based on the information on the type of the first mobile terminal.

### (Supplementary Note 7)

A control apparatus including:
a communication processing section configured to receive, from a management apparatus managing a plurality of zones, information on allocation of the plurality of zones allocated to a flight airspace allowing a plurality of mobile terminals to be flown, the plurality of mobile terminals being configured to respectively perform wireless communication with a plurality of mobile communication carrier networks, the information being information on the allocation of the plurality of zones, each of which being identified by latitude, longitude, and altitude as a three-dimensional space in common among the plurality of mobile communication carrier networks; and
a control section configured to perform processing for one or more first mobile terminals being configured to perform wireless communication with a first mobile communication carrier network, based on the information on the allocation of the plurality of zones.

### (Supplementary Note 8)

The control apparatus according to supplementary note 7, wherein
the control apparatus is a network node in the first mobile communication carrier network.

### (Supplementary Note 9)

The control apparatus according to supplementary note 7 or 8, wherein
the control section is configured to perform processing for associating each of the plurality of zones and one or more area identifiers in the first mobile communication carrier network, based on the information on the allocation of the plurality of zones.

### (Supplementary Note 10)

The control apparatus according to supplementary note 9, wherein
the one or more area identifiers in the first mobile communication carrier network are each an identifier of a tracking area configured in the first mobile communication carrier network.

### (Supplementary Note 11)

The control apparatus according to supplementary note 9, wherein
the one or more area identifiers in the first mobile communication carrier network are each an identifier of one or more cells in the first mobile communication carrier network.

### (Supplementary Note 12)

The control apparatus according to any one of supplementary notes 9 to 11, further including:
an information acquisition section configured to acquire information on traffic in an area identified by the one or more area identifiers in the first mobile communication carrier network, wherein
the control section is configured to generate information on traffic in one or more zones associated with the one or more area identifiers, according to the information on the traffic, and
the communication processing section is configured to transmit the information on the traffic in the one or more zones to the management apparatus.

### (Supplementary Note 13)

The control apparatus according to any one of supplementary notes 9 to 12, wherein
the communication processing section is configured to further receive information instructing cancellation of a flight in a first zone from the management apparatus, and
the control section is configured to notify one or more mobile terminals present in an area identified with one or more area identifiers associated with the first zone, of the information instructing cancellation of the flight.

### (Supplementary Note 14)

The control apparatus according to supplementary note 13, wherein
the information instructing cancellation of the flight is included in a Public Warning System (PWS) notification or a broadcast message of a Cell Broadcast Service (CBS).

### (Supplementary Note 15)

The control apparatus according to any one of supplementary notes 7 to 14, wherein
the communication processing section is configured to further receive, from the management apparatus, information on a flight path including one or more zones in which the flight of the one or more first mobile terminals is permitted, and
the control section is configured to configure a radio resource for the flight of the one or more first mobile terminals, based on the information on the flight path including the one or more zones in which the flight of the one or more first mobile terminals is permitted.

### (Supplementary Note 16)

A method including:
allocating a plurality of zones, each of which being identified by latitude, longitude, and altitude as a three-dimensional space in common among a plurality of mobile communication carrier networks, to a flight airspace allowing a plurality of mobile terminals to be flown, the plurality of mobile terminals being configured to respectively perform wireless communication with the plurality of mobile communication carrier networks; and
transmitting information on allocation of the plurality of zones to the plurality of mobile communication carrier networks.

### (Supplementary Note 17)

A method including:
receiving, from a management apparatus managing a plurality of zones, information on allocation of the plurality of zones allocated to a flight airspace allowing a plurality of mobile terminals to be flown, the plurality of mobile terminals being configured to respectively perform wireless communication with a plurality of mobile communication carrier networks, the information being information on the allocation of the plurality of zones, each of which being identified by latitude, longitude, and altitude as a three-dimensional space in common among the plurality of mobile communication carrier networks; and
performing processing for one or more first mobile terminals being configured to perform wireless communication with a first mobile communication carrier network, based on the information on the allocation of the plurality of zones.

### (Supplementary Note 18)

A program that causes a processor to execute:
allocating a plurality of zones, each of which being identified by latitude, longitude, and altitude as a three-dimensional space in common among a plurality of mobile communication carrier networks to a flight airspace allowing a plurality of mobile terminals to be flown, the plurality of mobile terminals being configured to respectively perform wireless communication with the plurality of mobile communication carrier networks; and
transmitting information on allocation of the plurality of zones to the plurality of mobile communication carrier networks.

### (Supplementary Note 19)

A program that causes a processor to execute:
receiving, from a management apparatus managing a plurality of zones, information on allocation of the plurality of zones allocated to a flight airspace allowing a plurality of mobile terminals to be flown, the plurality of mobile terminals being configured to respectively perform wireless communication with a plurality of mobile communication carrier networks, the information being information on the allocation of the plurality of zones, each of which being identified by latitude, longitude, and altitude as a three-dimensional space in common among the plurality of mobile communication carrier networks; and
performing processing for one or more first mobile terminals being configured to perform wireless communication with a first mobile communication carrier network, based on the information on the allocation of the plurality of zones.

### (Supplementary Note 20)

A non-transitory computer readable recording medium storing a program that causes a processor to execute:
allocating a plurality of zones, each of which being identified by latitude, longitude, and altitude as a three-dimensional space in common among a plurality of mobile communication carrier networks, to a flight airspace allowing a plurality of mobile terminals to be flown, the plurality of mobile terminals being configured to respectively perform wireless communication with the plurality of mobile communication carrier networks; and
transmitting information on allocation of the plurality of zones to the plurality of mobile communication carrier networks.

### (Supplementary Note 21)

A non-transitory computer readable recording medium storing a program that causes a processor to execute:
receiving, from a management apparatus managing a plurality of zones, information on allocation of the plurality of zones allocated to a flight airspace allowing a plurality of mobile terminals to be flown, the plurality of mobile terminals being configured to respectively perform wireless communication with a plurality of mobile communication carrier networks, the information being information on the allocation of the plurality of zones, each of which being identified by latitude, longitude, and altitude as a three-dimensional space in common among the plurality of mobile communication carrier networks; and
performing processing for one or more first mobile terminals being configured to perform wireless communication with a first mobile communication carrier network, based on the information on the allocation of the plurality of zones.

This application claims priority based on JP 2019-161402 filed on Sep. 4, 2019, the entire disclosure of which is incorporated herein.

### INDUSTRIAL APPLICABILITY

In a system in which a flight of a mobile terminal is performed, a flight of a mobile terminal that performs wireless communication with a mobile communication carrier network can be appropriately supported.

### REFERENCE SIGNS LIST

1, 5 System
2, 2a, 2b, 2c Mobile Communication Carrier Network
3, 3a, 3b, 3c Mobile Terminal
40 Flight Airspace
41 Zone
100, 500 Management Apparatus
200 Flight Control Apparatus
600 Control Apparatus
131, 511 Allocation Processing Section
133, 231, 513, 611 Communication Processing Section
135 Determination Section
137 Configuration Section
233, 613 Control Section
235 Information Acquisition Section

What is claimed is:

1. A method for a mobile terminal comprising:
sending, to a network node, a message for inter-terminal communication with a neighbouring mobile terminal;
receiving, from the network node, a message including authorization information for the inter-terminal communication;
receiving, from the neighbouring mobile terminal, a message including position information; and
performing a collision avoidance with the neighbouring mobile terminal, based on the message including position information.

2. The method according to claim 1, wherein the mobile terminal is an Unmanned Aerial Vehicle (UAV).

3. The method according to claim 1, wherein the message for inter-terminal communication with the neighbouring mobile terminal includes identification information of the neighbouring mobile terminal.

4. The method according to claim 1, wherein the message for inter-terminal communication with the neighbouring mobile terminal includes information on flight path information.

5. The method according to claim 1, wherein the mobile terminal performs the inter-terminal communication during landing in a same tracking area.

6. The method according to claim 1, wherein the network node sends, to the mobile terminal, information related to a flight.

7. The method according to claim 6, wherein the information related to the flight indicates a plurality of zones capable of identifying a three-dimensional space in common among a plurality of mobile communication carrier networks.

8. A mobile terminal comprising:
a memory; and
at least one processor configured to access the memory,
wherein the at least one processor is further configured to:
send, to a network node, a message for inter-terminal communication with a neighbouring mobile terminal,
receive, from the network node, a message including authorization information for the inter-terminal communication,
receive, from the neighbouring mobile terminal, a message including position information, and
perform a collision avoidance with the neighbouring mobile terminal based on the message including position information.

9. A method for a network node comprising:
receiving, from a mobile terminal, a message for inter-terminal communication with a neighbouring mobile terminal, and
sending, to the mobile terminal, a message including authorization information for the inter-terminal communication.

10. A network node comprising:
a memory; and
at least one processor configured to access the memory,
wherein the at least one processor is further configured to:
receive, from a mobile terminal, a message for inter-terminal communication with a neighbouring mobile terminal, and
send, to the mobile terminal, a message including authorization information for the inter-terminal communication.
